(19) United States
(12) Patent Application Publication
(10) Pub. No.: US 2009/0292468 A1
(43) Pub. Date: Nov. 26, 2009

(54) COLLISION AVOIDANCE METHOD AND SYSTEM USING STEREO VISION AND RADAR SENSOR FUSION

(76) Inventors: Shunguang Wu, Robbinsville, NJ (US); Theodore Camus, Marlton, NJ (US); Chang Peng, West Windsor, NJ (US)

Correspondence Address: PATENT DOCKET ADMINISTRATOR;LOWENSTEIN SANDLER P.C., 65 LIVINGSTON AVENUE, ROSELAND, NJ, 07068, US

(21) Appl. No.: 12/410,602

(22) Filed: Mar. 25, 2009

Related U.S. Application Data
(60) Provisional application No. 61/039,298, filed on Mar. 25, 2008.

(51) Int. Cl. G08G 1/16; G01S 13/08; G01S 13/00

(52) U.S. Cl. 701/301; 342/146; 342/118; 342/53; 342/54

(57) ABSTRACT

A system and method for fusing depth and radar data to estimate at least a position of a threat object relative to a host object is disclosed. At least one contour is fitted to a plurality of contour points corresponding to the plurality of depth values corresponding to a threat object. A depth closest point is identified on the at least one contour relative to the host object. A radar target is selected based on information associated with the depth closest point on the at least one contour. The at least one contour is fused with radar data associated with the selected radar target based on the depth closest point to produce a fused contour. Advantageously, the position of the threat object relative to the host object is estimated based on the fused contour. More generally, a method is provided for aligns two possibly disparate sets of 3D points.

### CROSS-REFERENCE TO RELATED APPLICATIONS

This application claims the benefit of U.S. provisional patent application No. 61/039,298 filed Mar. 25, 2008, the disclosure of which is incorporated herein by reference in its entirety.

### GOVERNMENT RIGHTS IN THIS INVENTION

This invention was made with U.S. government support under contract number 70NANB4H3044. The U.S. government has certain rights in this invention.

### FIELD OF THE INVENTION

The present invention relates generally to collision avoidance systems, and more particularly, to a method and system for estimating the position and motion information of a threat vehicle by fusing vision and radar sensor observations of 3D points.

### BACKGROUND OF THE INVENTION

Collision avoidance systems for automotive navigation have emerged as an increasingly important safety feature in today's automobiles. A specific class of collision avoidance systems that have generated significant interest of late is advanced driving assistant systems (ADAS). Exemplary ADAS include lateral guidance assistance, adaptive cruise control (ACC), collision sensing/avoidance, urban driving and stop and go situation detection, lane change assistance, traffic sign recognition, high beam automation, and fully autonomous driving. The efficacy of these systems depends on accurately sensing the spatial and temporal environment information of a host object (i.e., the object or vehicle hosting or including the ADAS system or systems) with a low false alarm rate. Exemplary temporal environment information may include present and future road and/or lane status information, such as curvatures and boundaries; and the location and motion information of on-road/off-road obstacles, including vehicles, pedestrians and the surrounding area and background.

FIG. 1 depicts a collision avoidance scenario involving a host vehicle 10 which may imminently cross paths with a threat vehicle 12. In this scenario, the host vehicle 10 is equipped with two sensors: a stereo camera system 14 and a radar sensor 16. The sensors 14, 16 are configured to estimate the position and motion information of the threat vehicle 12 with respective to the host vehicle 10. The radar sensor 16 is configured to report ranges and azimuth angles (lateral) of scattering centers on the threat vehicle 12, while the stereo camera system 14 measures the locations of the left and right boundaries, contour points, and the velocity of the threat vehicle 12. It is known to those skilled in the art that the radar sensor 16 is configured to provide high resolution range measurement (i.e., the distance to the threat vehicle 12). Unfortunately, the radar sensor 16 provides poor azimuth angular (lateral) resolution, as indicated by radar error bounds 18. Large azimuth angular error or noise are typically attributed to limitations of the measurement capabilities of the radar sensor 16 and to a non-fixing reflection point on the rear part of the threat vehicle 12.

Conversely, the stereo camera system 14 may be configured to provide high quality angular measurements (lateral resolution) to identify the boundaries of the threat vehicle 12, but poor range estimates, as indicated by the vision error bounds 20. Moreover, although laser scanning radar can detect the occupying area of the threat vehicle 12, it is prohibitively expensive for automotive applications. In addition, affordable automotive laser detection and ranging (LADAR) can only reliably detect reflectors located on a threat vehicle 12 and cannot find all occupying areas of the threat vehicle 12.

In order to overcome the deficiencies associated with using either the stereo camera system 14 and the radar sensor 16 alone, certain conventional systems attempt to combine the lateral resolution capabilities of the stereo camera system 14 with the range capabilities of the radar sensor 16, i.e., to “fuse” multi-modality sensor measurements. Fusing multi-modality sensor measurements helps to reduce error bounds associated with each measurement alone, as indicated by the fused error bounds 22.

Multi-modal prior art fusion techniques are fundamentally limited because they treat the threat car as a point object. As such, conventional methods/systems can only estimate the location and motion information of the threat car (relative to the distance between the threat and host vehicles) when it is far away (the size of the threat car does not a matter) from the sensors. However, when the threat vehicle is close to the host vehicle (<20 meters away), the conventional systems fail to consider the shape of the threat vehicle. Accounting for the shape of the vehicle provides for greater accuracy in determining if a collision is imminent.

Accordingly, what would be desirable, but has not yet been provided, is a method and system for fusing vision and radar sensing information to estimates the position and motion of a threat vehicle modeled as a rigid body object at close range, preferably less than about 20 meters from a host vehicle.

### SUMMARY OF THE INVENTION

The above-described problems are addressed and a technical solution achieved in the art by providing a method for fusing depth and radar data to estimate at least a position of a threat object relative to a host object, the method comprising the steps of: receiving a plurality of depth values corresponding to at least the threat object; receiving radar data corresponding to the threat object; fitting at least one contour to a plurality of contour points corresponding to the plurality of depth values; identifying a depth closest point on the at least one contour relative to the host object; selecting a radar target based on information associated with the depth closest point on the at least one contour; fusing the at least one contour with radar data associated with the selected radar target based on the depth closest point on the at least one contour to produce a fused contour; and estimating at least the position of the threat object relative to the host object based on the fused contour.

According to an embodiment of the present invention, fusing the at least one contour with radar data associated with the selected radar target further comprises the steps of: fusing ranges and angles of the radar data associated with the selected radar target and the depth closest point on the at least one contour to form a fused closest point and translating the at least one contour to the fused closest point to form the fused contour, wherein the fused closest point is invariant. Translating the at least one contour to the fused closest point to form the fused contour further comprises the step of translating the at least one contour along a line formed on the origin of a coordinate system centered on the host object and the depth closest point to an intersection of the line and an arc formed by rotation of a central point associated with a best candidate radar target location about the origin of the coordinate system, wherein the best candidate radar target is selected from a plurality of radar targets by comparing Mahalanobis distances from the depth closest point to each of the plurality of radar targets.

According to an embodiment of the present invention, fitting at least one contour to the plurality of contour points corresponding to the plurality of depth values further comprises the steps of: fitting at least one contour to a plurality of contour points corresponding to the depth values further comprises the steps of: extracting the plurality of contour points from the plurality of depth values, and fitting a rectangular model to the plurality of contour points. Fitting a rectangular model to the plurality of contour points further comprises the steps of: fitting a single line segment to the plurality of contour points to produce a first candidate contour, fitting two perpendicular line segments joined at one point to the plurality of contour points to produce a second candidate contour, and selecting a final contour according to a comparison of weighted fitting errors of the first and second candidate contours. The single line segment of the first candidate contour is fit to the plurality of contour points such that a sum of perpendicular distances to the single line segment is minimized, and the two perpendicular line segments of the second candidate contour is fit to the plurality of contour points such that the sum of perpendicular distances to the two perpendicular lines segments is minimized. At least one of the single line segment and the two perpendicular line segments are fit to the plurality of contour points using a linear least squares model. The two perpendicular line segments are fit to the plurality of contour points by: finding a leftmost point (L) and a rightmost point (R) on the two perpendicular line segments, forming a circle wherein the L and the R are points on a diameter of the circle and C is another point on the circle, calculating perpendicular errors associated with the line segments LC and RC, and moving C along the circle to find a best point (C′) such that the sum of the perpendicular errors associated with the line segments LC and RC is the smallest. According to an embodiment of the present invention, the method may further comprise estimating location and velocity information associated with the selected radar target based at least on the radar data.

According to an embodiment of the present invention, the method may further comprise the step of tracking the fused contour using an Extended Kalman Filter.

According to an embodiment of the present invention, a system for fusing depth and radar data to estimate at least a position of a threat object relative to a host object is provided, wherein a plurality of depth values corresponding to the threat object are received from a depth sensor, and radar data corresponding to at least the threat object is received from a radar sensor, comprising: a depth-radar fusion system communicatively connected to the depth sensor and the radar sensor, the depth-radar fusion system comprising: a contour fitting module configured to fit at least one contour to a plurality of contour points corresponding to the plurality of depth values, a depth-radar fusion module configured to: identify a depth closest point on the at least one contour relative to the host object, select a radar target based on information associated with the depth closest point on the at least one contour, and fuse the at least one contour with radar data associated with the selected radar target based on the depth closest point on the at least one contour to produce a fused contour; and a contour tracking module configured to estimate at least the position of the threat object relative to the host object based on the fused contour.

The depth sensor may be at least one of a stereo vision system comprising one of a 3D stereo camera and two monocular cameras calibrated to each other, an infrared imaging systems, light detection and ranging (LIDAR), a line scanner, a line laser scanner, Sonar, and Light Amplification for Detection and Ranging (LADAR). The position of the threat object may be fed to a collision avoidance implementation system. The position of the threat object may be the location, size, pose and motion parameters of the threat object. The host object and the threat object may be vehicles.

Although embodiments of the present invention relate to the alignment of radar sensor and stereo vision sensor observations, other embodiments of the present invention relate to aligning two possibly disparate sets of 3D points. For example, according to another embodiment of the present invention, a method is described as comprising the steps of: receiving a first set of one or more 3D points corresponding to the threat object; receiving a second set of one or more 3D points corresponding to at least the threat object; selecting a first reference point in the first set; selecting a second reference point in the second set; performing a weighted average of a location of the first reference point and a location of the second reference point to form a location of a third fused point; computing a 3D translation of the location of the first reference point to the location of the third fused point; translating the first set of one or more 3D points according to the computed 3D translation; and estimating at least the position of the threat object relative to the host object based on the translated first set of one or more 3D points.

### BRIEF DESCRIPTION OF THE DRAWINGS

The present invention may be more readily understood from the detailed description of an exemplary embodiment presented below considered in conjunction with the attached drawings and in which like reference numerals refer to similar elements and in which:

FIG. 1 depicts an exemplary collision avoidance scenario of a host vehicle and a threat vehicle;

FIG. 2 illustrates an exemplary depth-radar fusion system and related process flow, according to an embodiment of the present invention;

FIGS. 3A and 3B graphically illustrate an exemplary contour fitting process for fitting of contour points of a threat vehicle to a 3-point contour, according to an embodiment of the present invention;

FIG. 4A graphically depicts an exemplary implementation of a depth-radar fusion process, according to an embodiment of the present invention;

FIG. 4B depicts a contour tracking state vector and associated modeling, according to an embodiment of the present invention;

FIG. 5 is a process flow diagram illustrating exemplary steps for fusing vision information and radar sensing information to estimate a position and motion of a threat vehicle, according to an embodiment of the present invention;

FIG. 6 is a process flow diagram illustrating exemplary steps of a multi-target tracking (MTT) method for tracking candidate threat vehicles identified by radar measurements, according to an embodiment of the present invention;

FIG. 7 is a block diagram of an exemplary system configured to implement a depth-radar fusion process, according to an embodiment of the present invention;

FIG. 8 depicts three example simulation scenarios wherein a host vehicle moves toward a threat vehicle by a constant velocity and the threat vehicle is stationary for use with an embodiment of the present invention;

FIGS. 9-12 are normalized histograms of error distributions of Monte Carlo Runs in exemplary range intervals of [0.5)m, [5.10)m, [10.15)m, and [15.20)m, respectively, calculated in accordance with embodiments of the present invention;

FIG. 13 shows an application of an exemplary depth-radar fusion process to two video images and an overhead view of a threat vehicle in relation to a host vehicle; and

FIG. 14 compares the closest points from vision, radar and fusion results with GPS data, wherein the fusion results provide the closest match to the GPS data.

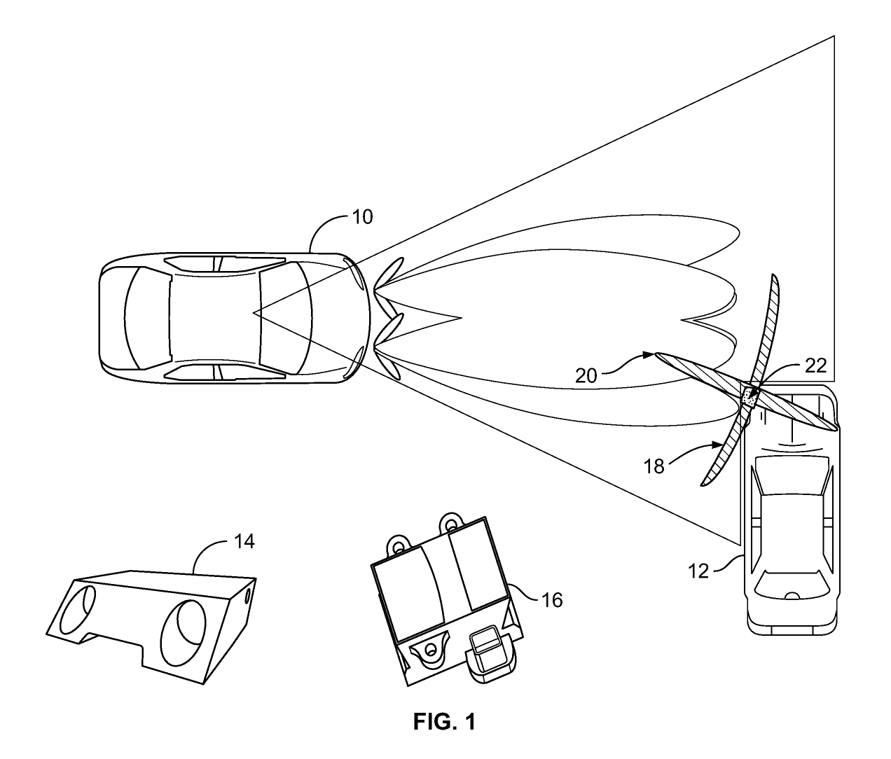

It is to be understood that the attached drawings are for purposes of illustrating the concepts of the invention and may not be to scale.

### DETAILED DESCRIPTION OF THE INVENTION

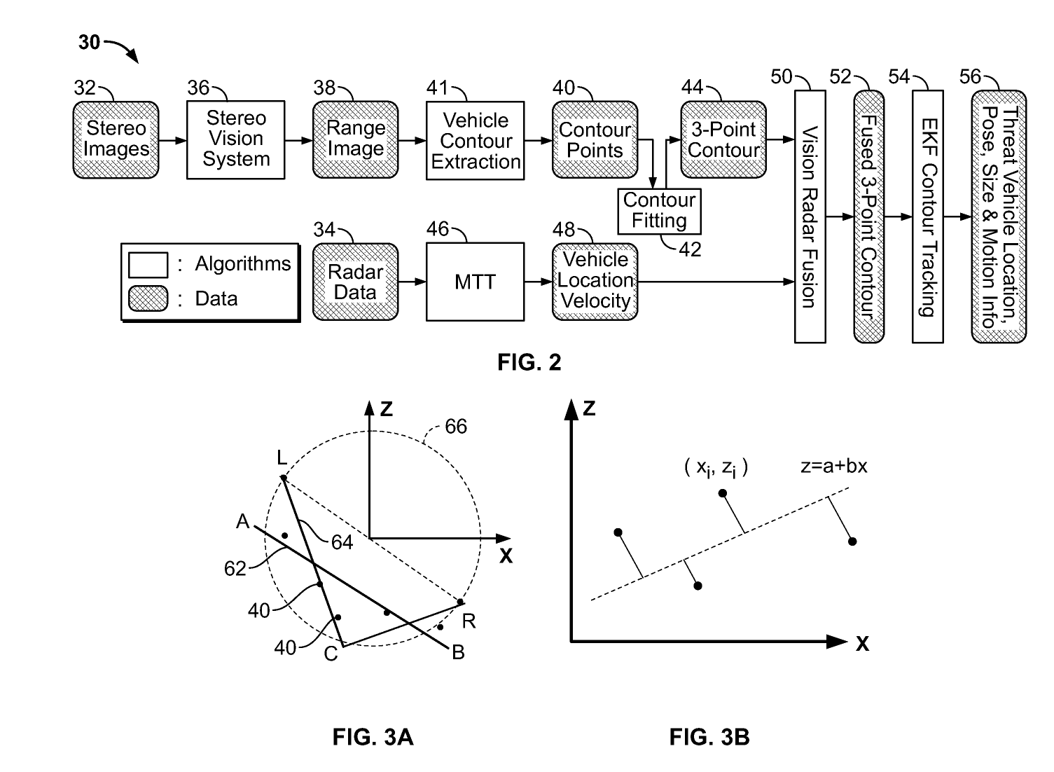

FIG. 2 presents a block diagram of a depth-radar fusion system 30 and related process, according to an illustrative embodiment of the present invention. According to an embodiment of the present invention, the inputs of the depth-radar fusion system 30 include left and right stereo images 32 generated by a single stereo 3D camera, or, alternatively, a pair of monocular cameras whose respective positions are calibrated to each other. According to an embodiment of the present invention, the stereo camera is mounted on a host object, which may be, but is not limited to, a host vehicle. The inputs of the depth-radar fusion system 30 further include radar data 34, comprising ranges and azimuthes of radar targets, and generated by any suitable radar sensor/system known in the art.

A stereo vision module 36 accepts the stereo images 32 and outputs a range image 38 associated with the threat object, which comprise a plurality of at least one of 1, 2, or 3-dimensional depth values (i.e., scalar values for one dimension and points for two or three dimensions). Rather than deriving the depth values from a stereo vision system 36 employed as a depth sensor, the depth values may alternatively be produced by other types of depth sensors, including, but not limited to, infrared imaging systems, light detection and ranging (LIDAR), a line scanner, a line laser scanner, Sonar, and Light Amplification for Detection and Ranging (LADAR).

According to an embodiment of the present invention, a contour may be interpreted as an outline of at least a portion of an object, shape, figure and/or body, i.e., the edges or lines that defines or bounds a shape or object. According to another embodiment of the present invention, a contour may be a 2-dimensional (2D) or 3-dimensional (3D) shape that is fit to a plurality of points on an outline of an object.

According to another embodiment of the present invention, a contour may be defined as points estimated to belong to a continuous 2D vertical projection of a cuboid-modeled object's visible 3D points. The 3D points (presumed to be from the threat vehicle 12) may be vertically projected to a flat plane, that is, the height (y) dimension is collapsed, and thus the set of 3D points yields a 2D contour on a flat plane. Optionally, a 2D contour may be fit to the 3D points, based on the 3D points' (x,z) coordinates, and not based on the (y) coordinate.

The contour (i.e., the contour points 40) of a threat object (e.g., a threat vehicle) may be extracted from the depth values associated with the range image 38 using a vehicle contour extraction module 41. The vehicle contour extraction module 41 may be, for example, a computer-based module configured to perform a segmentation process, such as the segmentation processes described in co-pending U.S. patent application Ser. No. 10/766,976 filed Jan. 29, 2004, and U.S. Pat. No. 7,263,209, which are incorporated herein by reference in their entirety.

The contour points 40 are fed to a contour fitting module 42 to be described hereinbelow in connection with FIG. 3. The contour fitting module 42 is a computer-based module configured to fit a rectangular model to the contour points 40. More particularly, at least one contour is fit to the contour points 40 corresponding to the depth values. By using the contour fitting module 42, a 3-point contour 44 may be represented by three points: the left, middle and right points of two perpendicular line segments for a two-side view scenario, or for the left, middle, and right points of a single line segment for one-side view scenario.

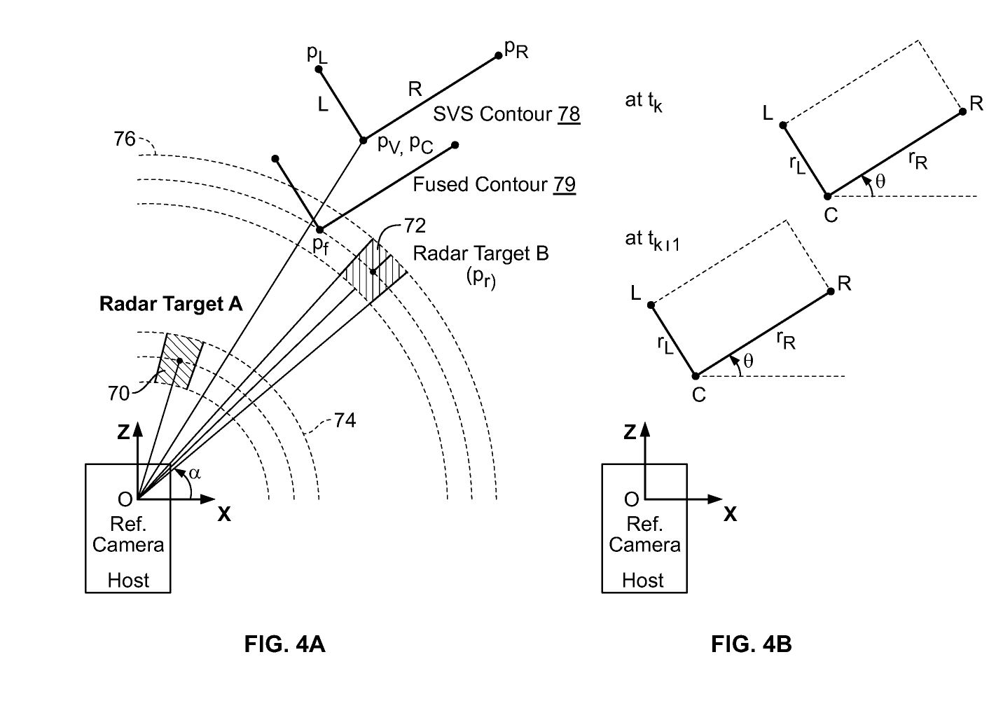

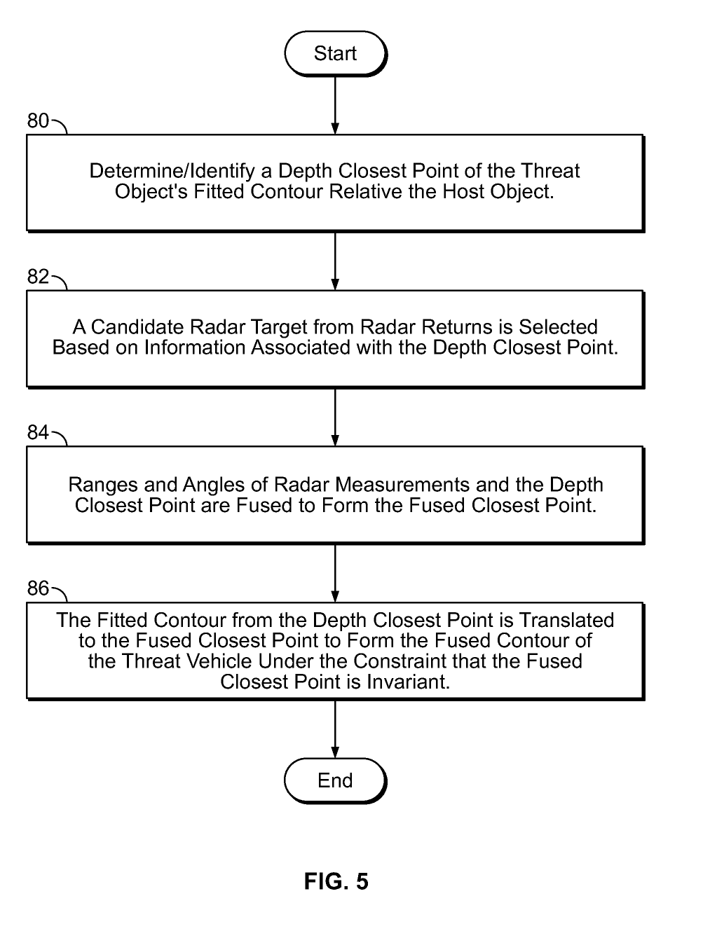

As shown in FIG. 2, the radar data 34 is fed to a multi-target tracking (MTT) module 46 to estimate the location and velocities 48 (collectively referred to as the “MTT outputs”) of each radar target (i.e., identified by the radar sensor/system as a potential threat vehicle). A depth-radar fusion module 50 is configured to perform a fusion process wherein the 3-point contours 44 and MTT outputs 48 are fused or combined to give more accurate fused 3-point contours 52. The functionality associated with the depth-radar fusion module 50 is described in detail in connection with FIGS. 4 and 5.

More particularly, depth-radar fusion module 50 finds a depth closest point on the 3-point contour 44 relative to the host object 10. The depth closest point is the point on the 3-point contour that is closest to the host vehicle 10. A radar target is selected based on information associated with the depth closest point on the 3-point contour 44. The 3-point contour 44 is fused with the radar data 34 associated with the selected radar target based on the depth closest point on the 3-point contour 44 to produce a fused contour. According to an embodiment of the present invention, the depth-radar fusion system 30 further comprises an extended Kalman filter 54 configured for tracking the fused contour 52 to estimate the threat vehicle's location, size, pose and motion parameters 56.

According to an embodiment of the present invention, a threat vehicle's 3-point contour 44 is determined from a plurality of contour points 40 based on depth (e.g., stereo vision (SV)) points/observations of the threat vehicle and the depth closest point on the contour of the threat vehicle relative to the host vehicle (i.e., the closest point as determined by the contour of the threat vehicle to the origin of a coordinate system centered on the host vehicle). FIGS. 3A and 3B graphically illustrate the contour fitting module 52 of FIG. 2 for fitting the contour points 40 to a 3-point contour 44. In FIG. 3A, the outline of a threat vehicle is represented by a plurality of contour points 40 in three dimensions, which have been extracted from stereo vision system (SVS) data using one of the contour extraction modules 41 described above. FIG. 3A presents an overhead view of the contour points 40, wherein the y-dimension is suppressed, such that the contour points 40 are viewed along the x and z directions of a coordinate system for simplicity. Although the contour points 40 of FIG. 3A are shown along a two dimensional projected plane, embodiments of the present invention work equally well with representations in one and three dimensions. In the case of three dimensions, the contour represents an edge of the threat vehicle's volume. The objective is to determine whether the volume of the threat vehicle may intersect the volume of the host vehicle, thereby detecting that a collision is imminent.

As shown in FIG. 3A, the contour of a threat vehicle can be represented by either one line segment 62 or two perpendicular line segments 64 (depending on the pose of a threat vehicle in the host vehicle reference system). The contour fitting module 42 fits the line segments from a set of contour points 40 such that the sum of perpendicular distances to either of the line segment 62, or two perpendicular lines segments 64 is minimized (see FIG. 3B).

For fitting the single line segment 62, the sum of the perpendicular distances from the contour points 40 to the line segment 62 is minimized. In a preferred embodiment, a perpendicular linear least square module is employed. More particularly, assuming the set of points (xᵢ,zᵢ) (i=1, n) are given (i.e., the contour points 40), the fitting module estimates line z=a+bx such that the sum of perpendicular distance D to the line is minimized, i.e.,

$$D = min \{ {\sum }_{i = 1}^{n} \frac{\vert {z}_{i} - a - {bx}_{i} \vert}{\sqrt{1 + {b}^{2}}} \} . \qquad ( 1 )$$

By taking a square for both sides of Equation (1), and letting

$$\frac{\partial {D}^{2}}{\partial a} = 0 , and \frac{\partial {D}^{2}}{\partial b} = 0 ,$$

then

$$a = \overline{z} - b \overline{x} , b = - B \pm \sqrt{{B}^{2} + 1} , where$$

$$\overline{x} = \frac{1}{n} {\sum }_{i = 1}^{n} {x}_{i} , \overline{z} = \frac{1}{n} {\sum }_{i = 1}^{n} {z}_{i} , B = \frac{( {\sum }_{i = 1}^{n} {z}_{i}^{2} - n \overline{z} ) - ( {\sum }_{i = 1}^{n} {x}_{i}^{2} - n \overline{x} )}{2 ( n \overline{xz} - {\sum }_{i = 1}^{n} {x}_{i} {z}_{i} )} .$$

To fit two perpendicular line segments 64, in a preferred embodiment of the present invention, a perpendicular linear least squares module is employed. More particularly, the most left and right points, L and R are found. A circle 66 is formed in which the line segment, LR is a diameter. Perpendicular errors are calculated to the line segments LC and RC. The point C is moved along the circle 66 to find a best point (C′) (i.e., the line segments LC and RC forming right traingles are adjusted along the circle 66) such that the sum of the perpendicular errors to the line segments LC′ and RC is the smallest. With the above fitted two candidate contours 62, 64, the final fitted contour is chosen by selecting the candidate contour with the minimum weighted fitted error.

Once the fitted contour of a threat vehicle and filtered radar objects are obtained, the depth-radar fusion module 50 adjusts the location of the fitted contour by using the radar data. FIG. 4A graphically depicts the elements of the depth-radar fusion module 50. FIG. 4B depicts the contour tracking state vector and its modeling. Referring now to FIG. 4A, the vision sensing camera of the host vehicle 12 is placed at an originan of a rectangular coordinate system. A plurality of radar targets A, B are plotted within the coordinate system, each of which forms an angle α with the horizontal axis. The range to each of the radar targets A,B are plotted within error bands 70, 72 and the respective azimuthel locations are plotted along the azimuthel bands 74, 76. The SVS contour 78 (i.e., the fitted contour) of the target vehicle is represented by the intersecting line segments L, R at point C. The two line segments L, R and intersection point C (or three points: p_{L}, p_{c}, and p_{R}) may represent the SVS contour 78 whether it is modeled as one or two line segment(s). If the SVS contour 78 is modeled as one line segment, p_{c} is its middle point.

FIG. 5 is a flow diagram illustrating exemplary steps for fusing vision and radar sensing information to estimates the location, size, pose and velocity of a threat vehicle, according to an embodiment of the present invention. After the 3-point contour 44 has been found by fitting the threat car contour (i.e., the SVS contour 78) to SVS contour points, in Step 80, the depth closest point, Pᵥ, on the SVS contour 78 (i.e., the closest point, Pᵥ, of the threat object's fitted contour relative to the host object) is found. Since the SVS contour 78 is represented by two line segments defined by three points p_{L}, p_{C}, and p_{R}, the depth closet point pᵥ may be chosen by comparing the two candidate closest points from origin to line segments p_{L}p_{C} and p_{c}P_{R}, respectively.

In step 82, a candidate radar target from radar returns is selected using depth closest point information. The best candidate radar target is selected from among the candidate radar targets A, B, based on its distance from the depth closest point pᵥ. More particularly, a candidate radar target, say pᵣ, may be selected from all radar targets by comparing the Mahalanobis distances from the depth closest point pᵥ to each the radar targets A, B.

In step 84, ranges and angles of radar measurements and the depth closest point pᵥ are fused to form the fused closest point p_{f}. The fused closest point p_{f} is found based on the depth closest point pᵥ and the best candidate radar target location. The ranges and azimuth angles of the depth closest point pᵥ and radar target pᵣ may be expressed as (dᵥ±σ_{J}_{ᵥ},αᵥ±σαᵥ), and (dᵣ±σ_{J}_{ᵣ},αᵣ±σ_{α}_{ᵣ}) respectively. The fused range and its uncertainty of the fused closest point p_{f} are expressed as follows:

$${d}_{f} = \frac{{d}_{v} {σ}_{{d}_{r}} + {d}_{r} {σ}_{{d}_{v}}}{{σ}_{{d}_{r}} + {σ}_{{d}_{v}}} , {σ}_{{d}_{f}} = \frac{{σ}_{{d}_{r}} {σ}_{{d}_{v}}}{{σ}_{{d}_{r}} + {σ}_{{d}_{v}}} \qquad ( 2 )$$

According to an embodiment of the present invention, the fused azimuth angle and its uncertainty may be calculated in a similar manner.

In step 86, the contour from the depth closest point pᵥ is translated to the fused closest point p_{f} to form the fused contour 79 of the threat vehicle under the constraint that the fused closest point p_{f} is invariant. The fused contour 79 can be obtained by translating the fitted contour from pᵥ to p_{f}. In graphical terms, the fused contour 79 is obtained by translating the SVS contour 132 along a line formed by the origin of a coordinate system centered on the host object and the depth closest point pᵥ to an intersection of the line and an arc formed by rotation of a central point associated with a best candidate radar target location about the origin of the coordinate system, wherein the best candidate radar target is selected from a plurality of radar targets by comparing Mahalanobis distances from the depth closest point pᵥ to each of the plurality of radar targets.

According to another embodiment of the present invention, th depth closest point and the radar data 34 may be combined according a weighted average.

Since false alarms and outliers may exist in both radar and vision processes, the fused contour 79 needs to be filtered before being reported to the collision avoidance implementation system 84 of FIG. 3. To this end, an Extended Kalman Filter (EKF) is employed to track the fused contour of a threat vehicle. As shown in FIG. 4B, the state vector of a contour is defined as

xₖ=[x_{c},\dot{x}_{c},z_{c},ż_{c},r_{L},r_{R},θ,\dot{θ}]ₖ^{T}, (3)

where c is the intersection point of the two perpendicular line segments if the contour is represented by two perpendicular lines, otherwise it stands for the middle of the one line segment; [x_{c},z_{c}] and [\dot{x}_{c},ż_{c}] are the location and velocity of point c in host reference system, respectively; r_{L} and r_{R} are respectively the left and right side lengthes of the vehicle, θ is the pose of the threat vehicle with respect to (w.r.t.) x-direction; and \dot{θ} stands for the pose rate.

By considering a rigid body constraint, the motion of the threat vehicle in the host reference coordinate system can be modeled as a translation of point c in the x-z plane and a rotation w.r.t. axis y, which is defined down to the ground in an overhead view. In addition, assuming a constant velocity model holds between two consecutive frames for both translation and rotation motion, the kinematic equation of the system can be expressed as

xₖ₊₁=Fₖxₖ+vₖ, (4)

where vₖ: N(0,Qₖ), and

Fₖ=diag{F_{cv},F_{cv},I₂,F_{cv}}, (5)

Qₖ=diag{σₓ²Q_{cv},σ_{z}²Q_{cv},σᵣ²I₂,σ_{θ}²Q_{cv}}. (6)

In (12) and (13), I₂ is a two dimensional identity matrix, F_{cv} and Q_{cv}, can be given by constant velocity model, σx, σ_{z}, σᵣ, and σ_{θ} are system parameters.

Since the positions of the three points L, C, and R can be measured from fusion results, the observation state vector is

zₖ=[x_{L},z_{L},x_{C},z_{C},x_{R},z_{R}]ₖ. (7)

According to the geometry, the measurement equation can be written as

zₖ=h(xₖ)+wₖ. (8)

where h is state to observation mapping function, and wₖ is the observation noise under a Gaussian distribution assumption.

Once the system and observation equations have been generated, the EKF is employed to estimate the contour state vector and its covariance at each frame.

The method according to an embodiment of the present invention receives the radar data 34 from a radar sensor, comprising range-azimuth pairs that represents the location of a scattering center (SC) (i.e, the point of highest reflectivity of the radar signal) of potential threat targets and feeds them through the MTT module to estimate the locations and velocities of the SCs. The MTT module may dynamically maintain (create/delete) tracked SCs by evaluating their track scores.

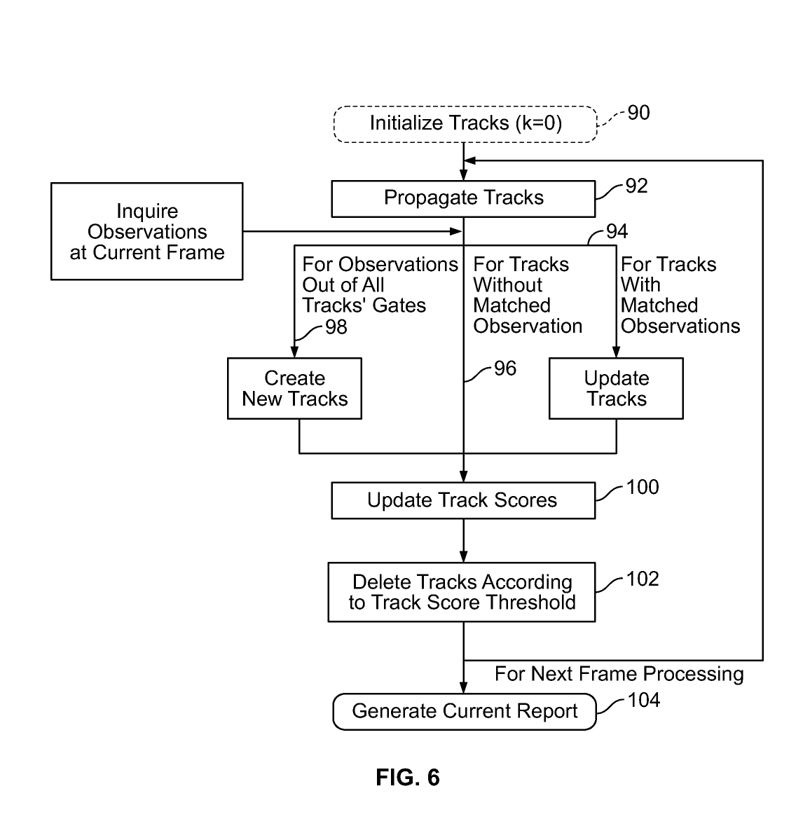

FIG. 6 presents a flow diagram illustrating exemplary steps performed by the MTT module, according to an embodiment of the present invention. In Step 90, tracks (i.e., the paths taken by potential targets) of detected SCs are initialized for a first frame of radar data. In Step 92, tracks are propagated. For tracks that have matched observations, at Step 94, these tracks are updated, and the module proceeds to Step 100. In Step 96, for tracks without matched observation, the module directly proceeds to Step 100. For observations that are beyond all the tracks' gates, at Step 98, at least one new track is created, and the module proceeds to Step 100. At Step 100, track scores are updated. At Step 102, if a track score falls below a predetermined track score threshold, then that track is deleted. Steps 92-102 are repeated for all subsequent frames of radar data. When all frames have been processed, at Step 104, a report is generated which includes the locations and velocities of the tracked SCs (i.e., the potential threat vehicles).

More particularly, the MTT module can be related to the state vector of each SC defined by

xₖ=[x,\dot{x},z,ż]ₖ^{T}, (9)

where (x,z) and (\dot{x},ż) are the location and velocity of the SC in radar coordinate system, which is mounted on the host vehicle. A constant velocity model is used to describe the kinematics of the SC, i.e.,

xₖ₊₁=Fₖxₖ+vₖ, (10)

where Fₖ is the transformation matrix, and v: N(0,Qₖ) (i.e., a normal distribution with zero mean and covariance Qₖ). The measurement state vector is

zₖ=[d,α]ₖ, 11)

and the measurement equations are

dₖ=\sqrt{xₖ²+zₖ²}+n_{d}(k),αₖ=tan⁻¹(zₖ/xₖ)+n_{α}(k), (12)

where both n_{d}(k) and n_{α}(k) are 1d Gaussian noise terms.

Since the measurement equations (12) are nonlinear, the standard Extended Kalman Filtering (EKF) module may be employed to perform state (track) propagation and estimation.

To evaluate the health status of each track, the track score of each SC is monitored. Assume M is the measurement vector dimension, P_{d} the detection probability, V_{c} the measurement volume element, P_{FA} the false alarm probability, H₀ the FA hypotheses, H₁ the true target hypotheses, β_{NT} the new target density, and yₛ the signal amplitude to noise ratio. The track score can be initialized as

$$L ( k = 0 ) = ln ( {β}_{NT} {V}_{c} ) + ln \frac{{P}_{d}}{{P}_{FA}} + ln [ \frac{p ( {y}_{s} \vert detect , {H}_{1} )}{p ( {y}_{s} \vert detect , {H}_{0} )} ] , \qquad ( 13 )$$

which can be updated by

$$\begin{matrix}L ( k ) = L ( k - 1 ) + Δ L ( k ) , \\ where & ( 14 ) \\ Δ L ( k ) = \{ \begin{matrix}ln ( 1 - {P}_{d} ) , & if track is not updated on scan k , \\ Δ {L}_{k} + Δ {L}_{s} , & otherwise ,\end{matrix} \\ Δ {L}_{k} = ln ( \frac{{V}_{c}}{\sqrt{\vert S \vert}} - \frac{1}{2} ( M ln ( 2 π ) + {\tilde{z}}^{′} {S}^{- 1} \tilde{z} ) , \\ Δ {L}_{s} = ln ( \frac{{P}_{d}}{{P}_{FA}} + ln [ \frac{p ( {y}_{s} \vert detect , {H}_{1} )}{p ( {y}_{s} \vert detect , {H}_{0} )} ] , & ( 15 )\end{matrix}$$

\tilde{z} and S are measurement innovation and its covariance, respectively.

Once the evolution curve of track score is obtained, a track can be deleted if L(k)−Lₘₐₓ<THD, where Lₘₐₓ is the maximum track score till tₖ, and THD is a track deletion threshold.

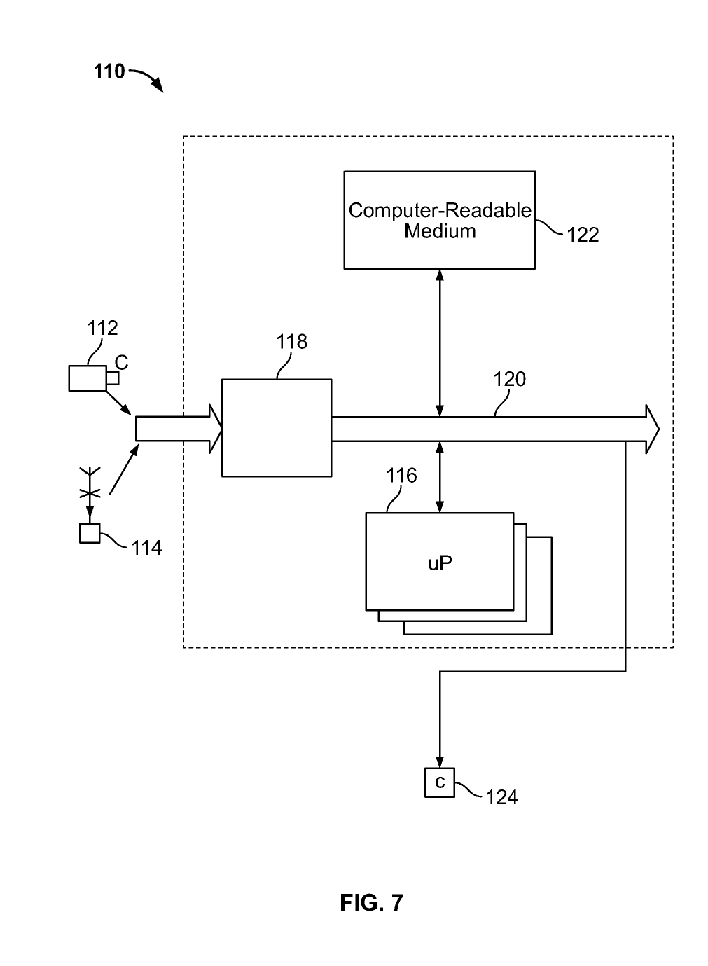

FIG. 7 presents a block diagram of a computing platform 110, configured to implement the process presented in FIG. 2, according to an embodiment of the present invention. The computing platform 110 receives the range image 38 produced by the stereo vision system 36. Alternatively, the computing platform 100 may implement the stereo vision system 36, and directly accept the left and right stereo images 32 from the single stereo 3D camera 112, or the pair of calibrated monocular cameras. The computing platform 110 also receives radar data 34 from the radar sensor/system 114. The computing platform 110 may include a personal computer, a work-station, or an embedded controller (e.g., a Pentium-M 1.8 GHz PC-104 or higher) comprising one or more processors 116 which includes a bus system 118 which is communicatively connected to the stereo vision system 36 and a radar sensor/system 114 via an input/output data stream 120. The input/output data stream 120 is communicatively connected to a computer-readable medium 122. The computer-readable medium 122 may also be used for storing the instructions of the computer platform 110 to be executed by the one or more processors 116, including an operating system, such as the Windows or the Linux operating system and the vehicle contour extraction, contour fitting, MTT, and depth-radar fusion methods of the present invention to be described hereinbelow. The computer-readable medium 122 may include a combination of volatile memory, such as RAM memory, and non-volatile memory, such as flash memory, optical disk(s), and/or hard disk(s). In one embodiment, the non-volatile memory may include a RAID (redundant array of independent disks) system configured at level 0 (striped set) that allows continuous streaming of uncompressed data to disk. The input/output data stream 120 may feed threat vehicle location, pose, size, and motion information to a collision avoidance implementation system 124. The collision avoidance implementation system 124 uses the position and motion information outputted by the computing platform 110 to take measures to avoid an impending collision.

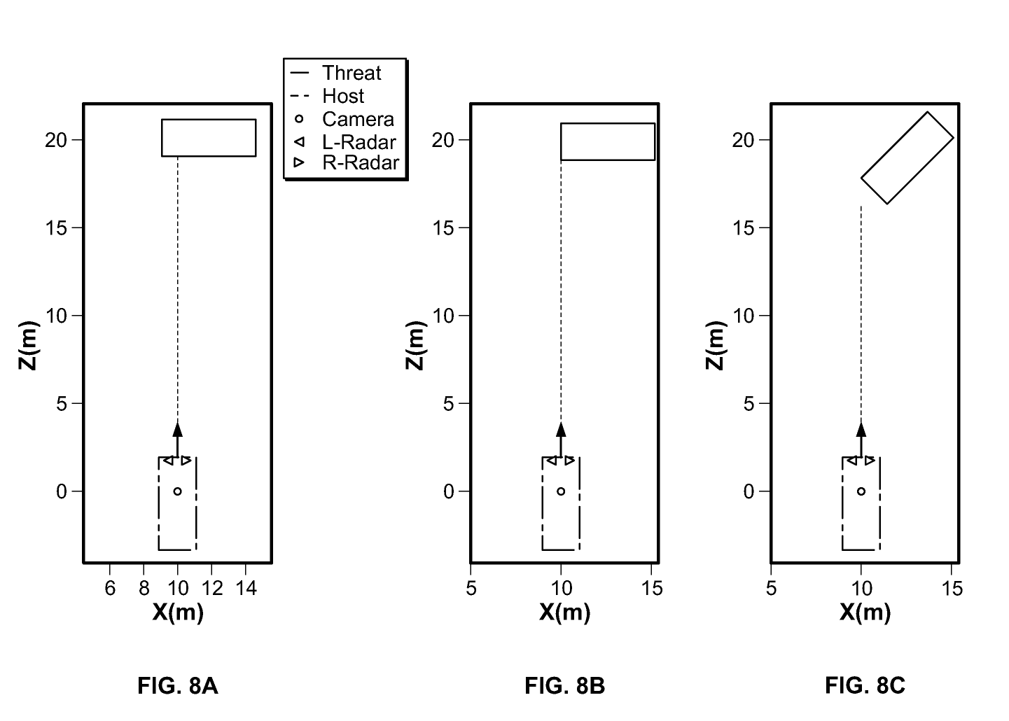

FIG. 8 depicts three example simulation scenarios wherein a host vehicle moves toward a stationary threat vehicle at a constant velocity (v_{z}) of 10 m/s. These scenarios cover both one-side and two-side views of the threat vehicle but a collision at different locations. The following parameters are used for generating synthetic radar and vision data. The radar range and azimuth noise standard deviation (STDs) are σᵣ=0.1 m and σ_{θ}=5 deg., respectively, while the vision noise STDs in x- and z-directions are calculated by

$${σ}_{x} = 2 \frac{z}{{f}_{x}} + 0.05 \vert x \vert and {σ}_{z} = 0.1 z ,$$

respectively. The sampling frequencies for both radar and stereo vision systems are choose as 30 Hz.

The synthetic observation for radar range and range-rate are generated by: rₖ= r̅ₖ+ξₖ, θₖ= θ̅ₖ+ζₖ, where ξ: N(0,σₜ), and ζₖ: N(0,σ_{θ}). The synthetic stereo vision observations are generated as follows: (i) given the ground truth of left, central, and right edge points noted as p_{L}, p_{C}, and p_{R}; (ii) uniformly sampling 17 points on the two line segments p_{L}p_{C} and p_{C}p_{R}; (iii) add Gaussian noise on each sampling points with local STDs of (0.05,0.1)m; and (iv) add same Gaussian noise with vision STDs on all points generated by (iii).

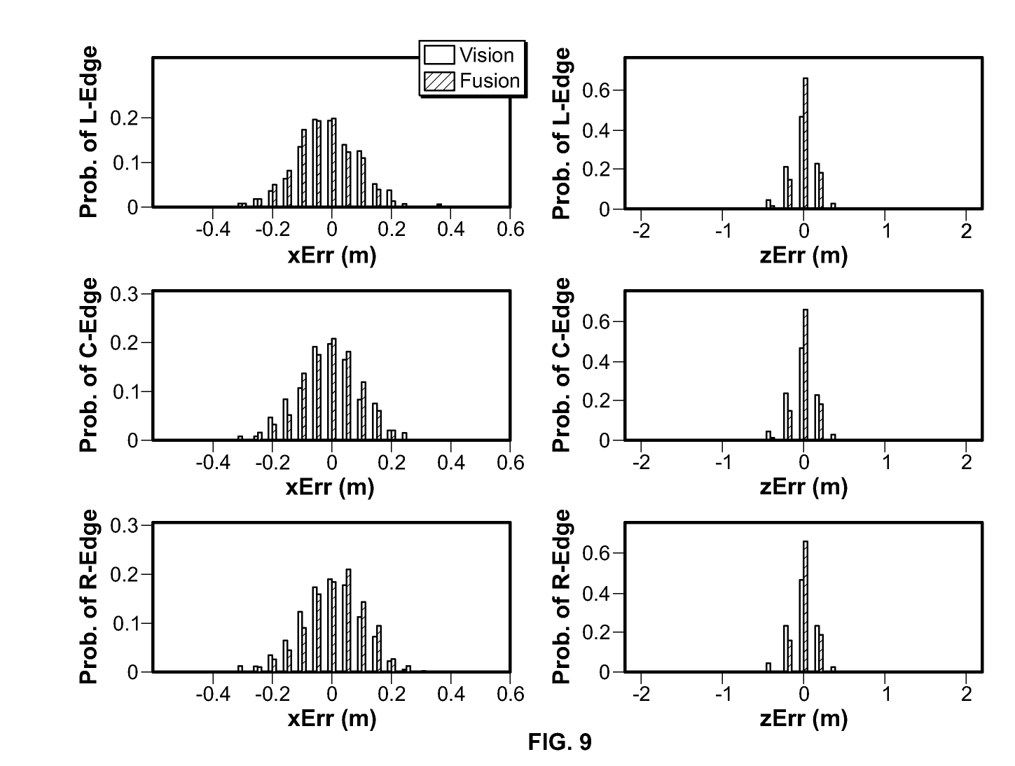

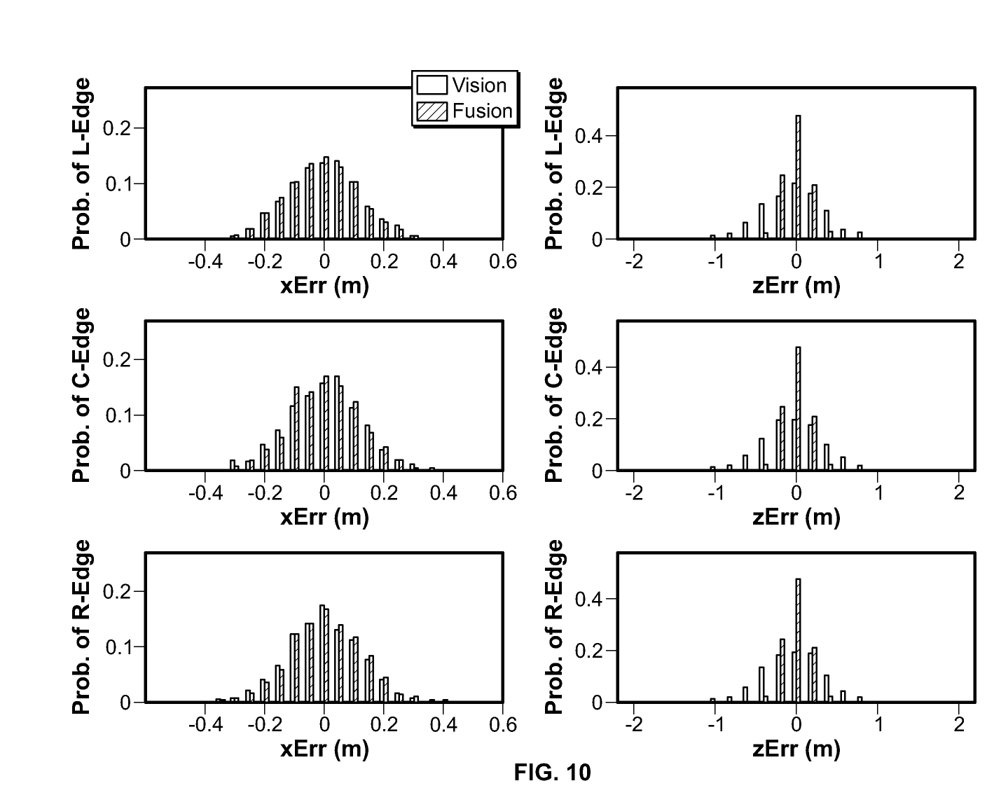

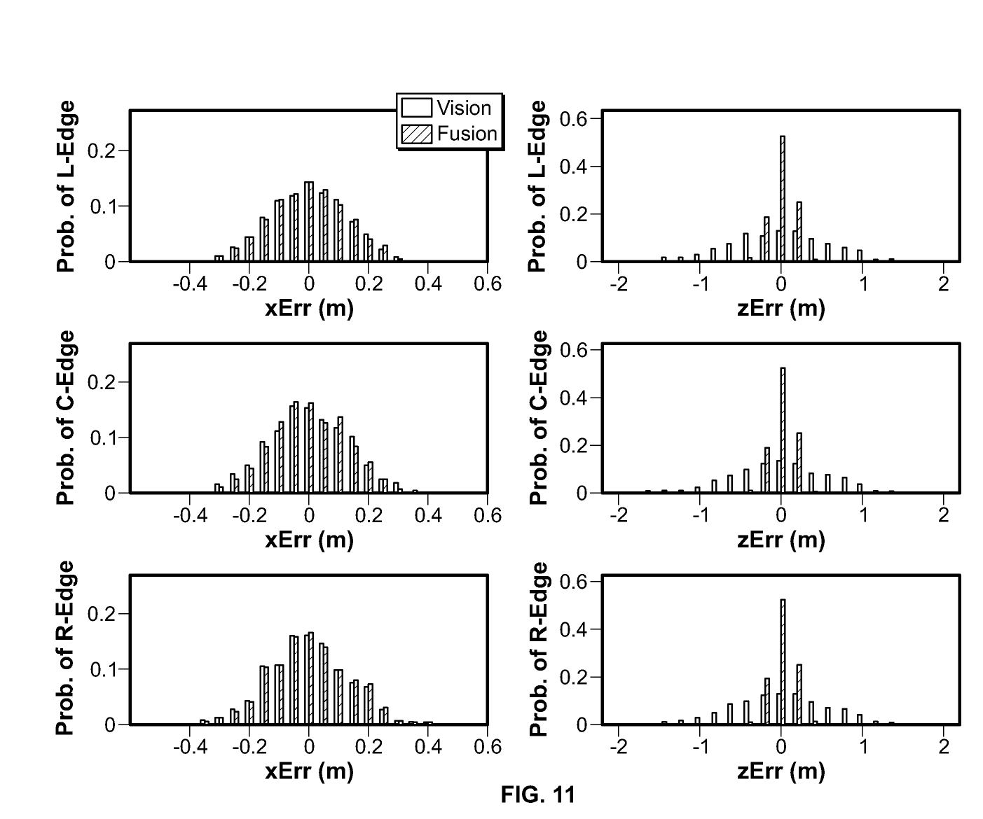

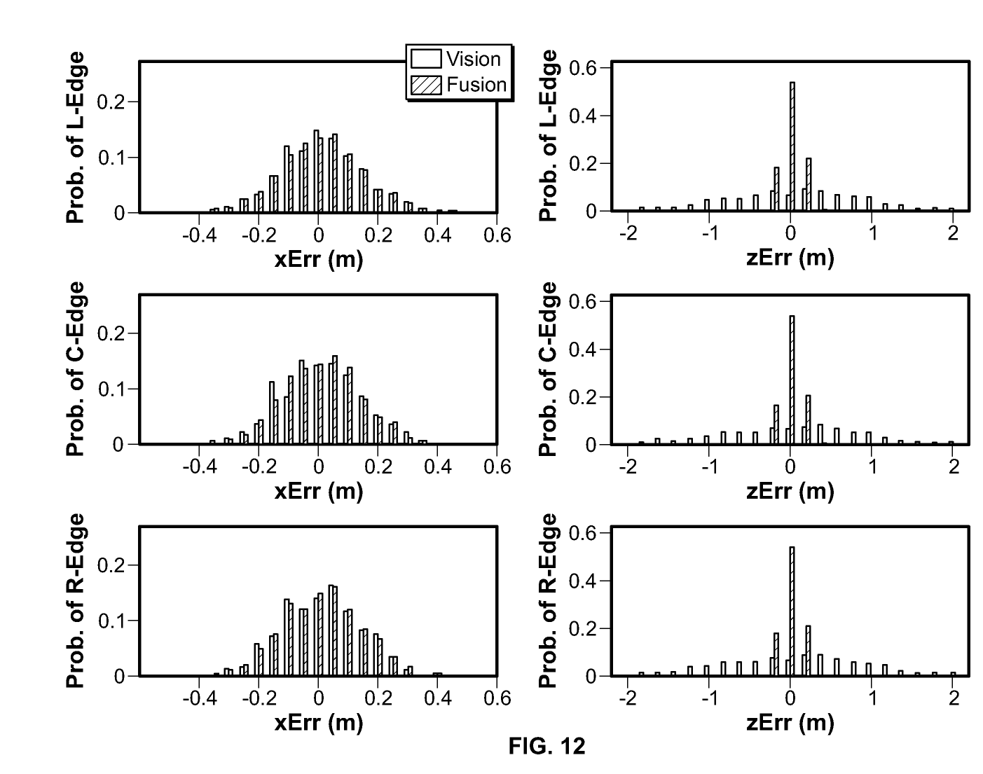

To evaluate the simulation results, the averaged errors from vision and fusion are calculated by

$${\overline{ɛ}}_{j} ( k ) = \frac{1}{N} {\sum }_{i = 1}^{N} [ {\hat{x}}_{j} ( k ) - {\overline{x}}_{j} ( k ) ] ,$$

where \hat{x} and x̅ are the estimated and the ground truth of one element of the state vector, N is the total number of Monte Carlo Runs (MCRs), and j=vision, fusion. The normalized histograms of error distributions in the range intervals [0.5)m, [5.10)m, [10.15)m, and [15.20)m respectively, are calculated. The results of scenario (a) are displayed in FIGS. 9-12, respectively.

From these results, the following conclusions can be gleaned: (i) there is no significant difference for the x-errors between vision and fused data, since the vision azimuth detection errors are already small enough (compared with radar) and the fusion module can not improve x-errors any further; (ii) the z-errors in the fused result are much smaller than that from vision alone, especially when the threat vehicles are far away from the host. The vision sensor at larger range gives larger observation error, and by fusing with the accurate radar observations, the overall range estimation accuracies are significantly improved.

Embodiments of the method described above were integrated into an experimental stereo vision based collision sensing system, and tested in a vehicle stereo vision and radar test bed.

An extensive road test was conducted using 2 vehicles driven 1500 miles. Driving conditions included day and night drive times, in weather ranging from clear to moderate rain and moderate snow fall. Testing was conducted in heavy traffic conditions, using an aggressive driving style to challenge the crash sensing modules.

During the driving tests, each sensor was configured with an object time-to-collision decision threshold, so that objects could be tracked as they approached the test vehicle. The object location time to collision threshold was located at 250 ms from contact, as determined by each individual sensor's modules and also by the sensor fusion module. As an object crossed the time threshold, raw data, module decision results, and ground truth data were recorded for 5 seconds prior to the threshold crossing, and 5 seconds after each threshold crossing. This allowed aggressive maneuvers to result in a 250 ms threshold crossings to happen from time to time during each test drive. The recorded data and module outputs were analyzed to determine system performance in each of the close encounters that happened during the driving tests.

During the 1500 miles of testing, 307 objects triggered the 250 mS time-to-collision threshold of the radar detection modules, and 260 objects triggered the vision systems 250 mS time-to-collision threshold. Eight objects triggered the fusion module based time-to-collision threshold. Post test data analysis determined that the eight fusion module based objects detected were all 250 mS or closer to colliding with the test car, while the other detections were triggered from noise in the trajectory prediction of objects that were upon analysis, found to be further away from the test vehicle when the threshold crossing was triggered.

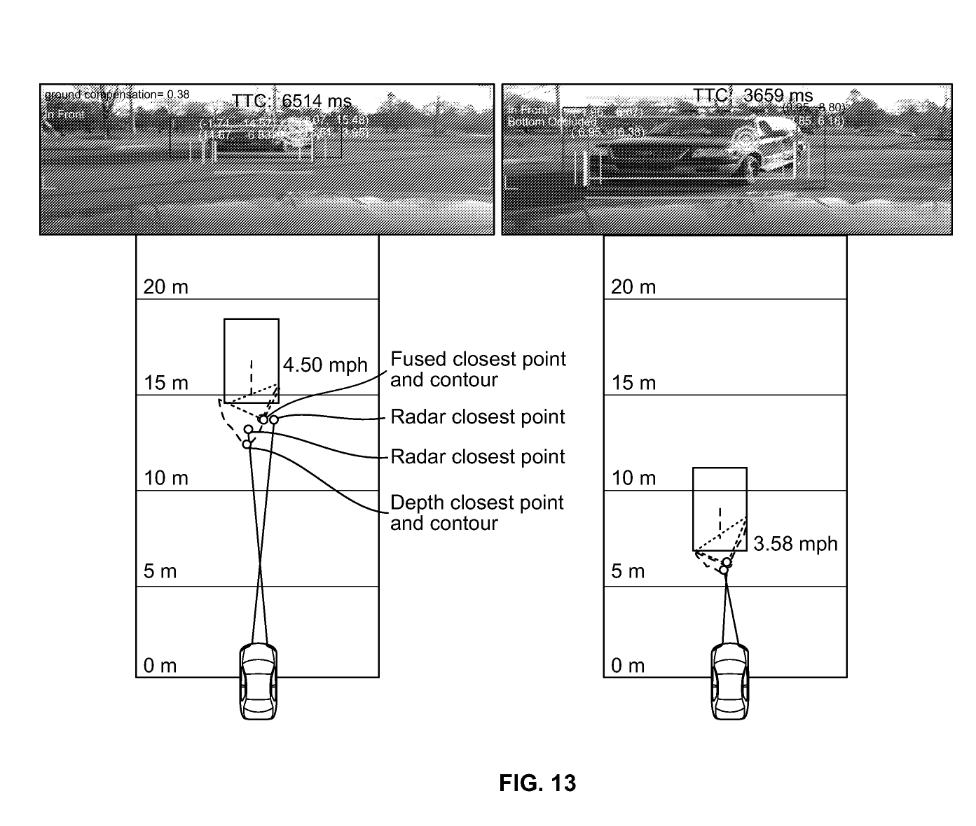

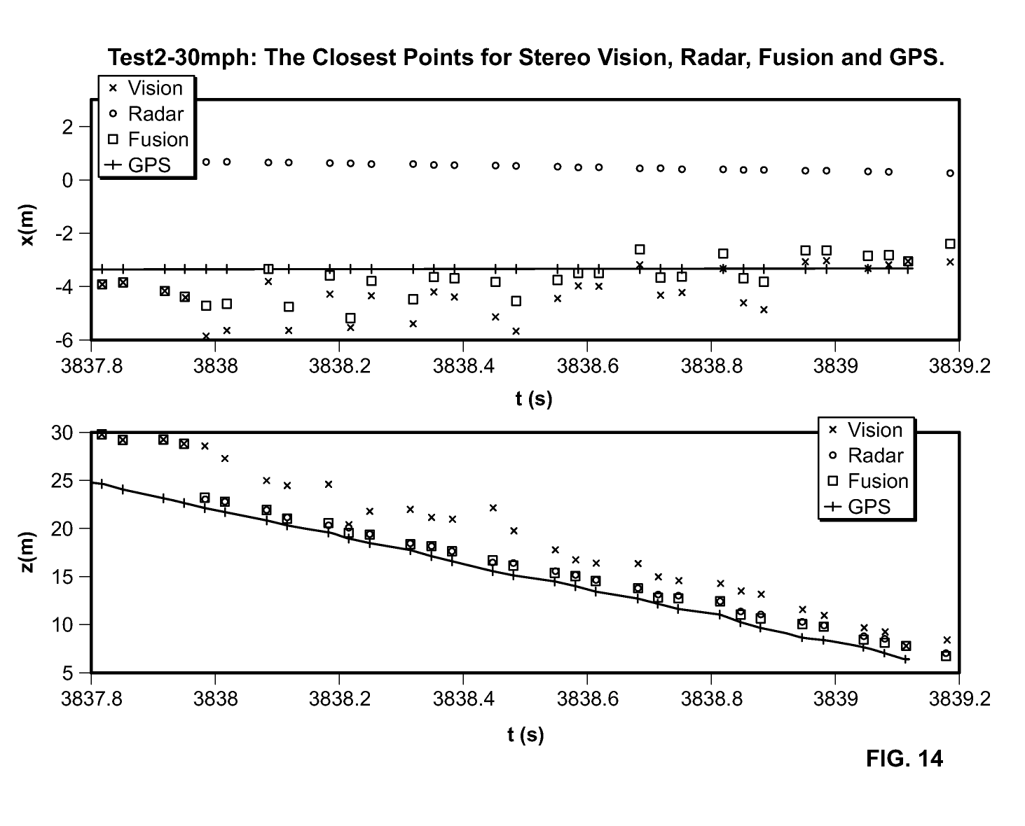

FIG. 13 shows two snapshots of the video and overhead view of the threat car with respect to host vehicle. FIG. 14 compares the closest points from vision, radar and fusion with GPS. In the example illustrated in FIG. 14, the threat vehicle was parked in the left front of the host car when the host car was driving straight forward at the speed about 30 mph. The fusion result shows the closest match to GPS data.

It is to be understood that the exemplary embodiments are merely illustrative of the invention and that many variations of the above-described embodiments may be devised by one skilled in the art without departing from the scope of the invention. It is therefore intended that all such variations be included within the scope of the following claims and their equivalents.

What is claimed is:

1. A computer-implemented method for fusing depth and radar data to estimate at least a position of a threat object relative to a host object, the method being executed by at least one processor, comprising the steps of:
receiving a plurality of depth values corresponding to the threat object;
receiving radar data corresponding to at least the threat object;
fitting at least one contour to a plurality of contour points corresponding to the plurality of depth values;
identifying a depth closest point on the at least one contour relative to the host object;
selecting a radar target based on information associated with the depth closest point on the at least one contour;
fusing the at least one contour with radar data associated with the selected radar target to produce a fused contour, wherein fusing is based on the depth closest point on the at least one contour; and
estimating at least the position of the threat object relative to the host object based on the fused contour.

2. The method of claim 1, wherein the step of fusing the at least one contour with radar data associated with the selected radar target further comprises the steps of:
fusing ranges and angles of the radar data associated with the selected radar target and the depth closest point on the at least one contour to form a fused closest point; and
translating the at least one contour to the fused closest point to form the fused contour, wherein the fused closest point is invariant.

3. The method of claim 2, wherein the step of translating the at least one contour to the fused closest point to form the fused contour further comprises the step of translating the at least one contour along a line formed on the origin of a coordinate system centered on the host object and the depth closest point to an intersection of the line and an arc formed by rotation of a central point associated with a best candidate radar target location about the origin of the coordinate system, wherein the best candidate radar target is selected from a plurality of radar targets by comparing Mahalanobis distances from the depth closest point to each of the plurality of radar targets.

4. The method of claim 1, wherein the step of fitting at least one contour to a plurality of contour points corresponding to the depth values further comprises the steps of:
extracting the plurality of contour points from the plurality of depth values, and
fitting a rectangular model to the plurality of contour points.

5. The method of claim 4, wherein the step of fitting a rectangular model to the plurality of contour points further comprises the steps of:
fitting a single line segment to the plurality of contour points to produce a first candidate contour,
fitting two perpendicular line segments joined at one point to the plurality of contour points to produce a second candidate contour, and
selecting a final contour according to a comparison of weighted fitting errors of the first and second candidate contours.

6. The method of claim 5, wherein the single line segment of the first candidate contour is fit to the plurality of contour points such that a sum of perpendicular distances to the single line segment is minimized, and wherein the two perpendicular line segments of the second candidate contour is fit to the plurality of contour points such that the sum of perpendicular distances to the two perpendicular lines segments is minimized.

7. The method of claim 6, wherein at least one of the single line segment and the two perpendicular line segments are fit to the plurality of contour points using a linear least squares model.

8. The method of claim 6, wherein the two perpendicular line segments are fit to the plurality of contour points by:
finding a leftmost point (L) and a rightmost point (R) on the two perpendicular line segments,
forming a circle wherein the L and the R are points on a diameter of the circle and C is another point on the circle,
calculating perpendicular errors associated with the line segments LC and RC, and
moving C along the circle to find a best point (C′) such that the sum of the perpendicular errors to the line segments LC and RC is the smallest.

9. The method of claim 1, further comprising the step of estimating location and velocity information associated with the selected radar target based at least on the radar data.

10. The method of claim 1, further comprising the step of tracking the fused contour using an Extended Kalman Filter.

11. A system for fusing depth and radar data to estimate at least a position of a threat object relative to a host object, wherein a plurality of depth values corresponding to the threat object are received from a depth sensor, and radar data corresponding to at least the threat object is received from a radar sensor, comprising:
a contour fitting module configured to fit at least one contour to a plurality of contour points corresponding to the plurality of depth values,
a depth-radar fusion module configured to:
identify a depth closest point on the at least one contour relative to the host object,
select a radar target based on information associated with the depth closest point on the at least one contour, and
fuse the at least one contour with radar data associated with the selected radar target based on the depth closest point on the at least one contour to produce a fused contour; and
a contour tracking module configured to estimate at least the position of the threat object relative to the host object based on the fused contour.

12. The system of claim 11, wherein the depth sensor is at least one of a stereo vision system comprising one of a 3D stereo camera and two monocular cameras calibrated to each other, an infrared imaging systems, light detection and ranging (LIDAR), a line scanner, a line laser scanner, Sonar, and Light Amplification for Detection and Ranging (LADAR).

13. The system of claim 11, wherein the at least the position of the threat object is fed to a collision avoidance implementation system.

14. The system of claim 11, wherein the at least the position of the threat object is the location, size, pose and motion parameters of the threat object.

15. The system of claim 11, wherein the host object and the threat object are vehicles.

16. The system of claim 11, wherein the said step of fusing the at least one contour with radar data associated with the selected radar target further comprises the steps of:
fusing ranges and angles of the radar data and the depth closest point on the at least one contour to form a fused closest point; and
translating the at least one contour to the fused closest point to form the fused contour, wherein the fused closest point is invariant.

17. The system of claim 16, wherein the step of translating the at least one contour to the fused closest point to form the fused contour further comprises the step of translating the at least one contour along a line formed by the origin of a coordinate system centered on the host object and the depth closest point to an intersection of the line and an arc formed by rotation of a central point associated with a best candidate radar target location about the origin of the coordinate system, wherein the best candidate radar target is selected from a plurality of radar targets by comparing Mahalanobis distances from the depth closest point to each of the plurality of radar targets.

18. A computer-readable medium storing computer code for fusing depth and radar data to estimate at least a position of a threat object relative to a host object, wherein the computer code comprises:
code for receiving a plurality of depth values corresponding to the threat object;
code for receiving radar data corresponding to at least the threat object;
code for fitting at least one contour to a plurality of contour points corresponding to the plurality of depth values;
code for identifying a depth closest point on the at least one contour relative to the host object;
code for selecting a radar target based on information associated with the depth closest point on the at least one contour;
code for fusing the at least one contour with radar data associated with the selected radar target based on the depth closest point on the at least one contour to produce a fused contour; and
code for estimating at least the position of the threat object relative to the host object based on the fused contour.

19. The computer-readable medium of claim 18, wherein the code for fusing the at least one contour with radar data associated with the selected radar target further comprises code for:
fusing ranges and angles of the radar data associated with the selected radar target and the depth closest point on the at least one contour to form a fused closest point and
translating the at least one contour to the fused closest point to form the fused contour, wherein the fused closest point is invariant.

20. The computer-readable medium of claim 19, wherein the code for translating the at least one contour to the fused closest point to form the fused contour further comprises code for translating the at least one contour along a line formed on the origin of a coordinate system centered on the host object and the depth closest point to an intersection of the line and an arc formed by rotation of a central point associated with a best candidate radar target location about the origin of the coordinate system, wherein the best candidate radar target is selected from a plurality of radar targets by comparing Mahalanobis distances from the depth closest point to each of the plurality of radar targets.

21. A computer-implemented method for estimating at least a position of a threat object relative to a host object, the method being executed by at least one processor, comprising the steps of:
receiving a first set of one or more 3D points corresponding to the threat object;
receiving a second set of one or more 3D points corresponding to at least the threat object;
selecting a first reference point in the first set;
selecting a second reference point in the second set;
performing a weighted average of a location of the first reference point and a location of the second reference point to form a location of a third fused point;
computing a 3D translation of the location of the first reference point to the location of the third fused point;
translating the first set of one or more 3D points according to the computed 3D translation; and
estimating at least the position of the threat object relative to the host object based on the translated first set of one or more 3D points.

22. The method of claim 21, wherein the first set of one or more 3D points is received from a first depth sensor comprising one of a stereo vision, radar, Sonar, LADAR, and LIDAR sensor.

23. The method of claim 22, wherein the first reference point is the closest point of the first depth sensor to the threat object.

24. The method of claim 21, wherein the second set of one or more 3D points is received from a second depth sensor comprising one of a stereo vision, radar, Sonar, LADAR, and LIDAR sensor.

25. The method of claim 24, wherein the second reference point is the closest point of the second depth sensor to the threat object.

26. A computer-readable medium storing computer code for estimating at least a position of a threat object relative to a host object, the method being executed by at least one processor, wherein the computer code comprises:
code for receiving a first set of one or more 3D points corresponding to the threat object;
code for receiving a second set of one or more 3D points corresponding to at least the threat object;
code for selecting a first reference point in the first set;
code for selecting a second reference point in the second set;
code for performing a weighted average of a location of the first reference point and a location of the second reference point to form a location of a third fused point;
code for computing a 3D translation of the location of the first reference point to the location of the third fused point;
code for translating the first set of one or more 3D points according to the computed 3D translation; and
code for estimating at least the position of the threat object relative to the host object based on the translated first set of one or more 3D points.
